(19) United States
(12) Patent Application Publication
(10) Pub. No.: US 2012/0257911 A1
(43) Pub. Date: Oct. 11, 2012

(54) IMAGE FORMING APPARATUS, DEVELOPER CARTRIDGE, AND METHOD OF ADJUSTING LENGTH OF THE DEVELOPER CARTRIDGE

(75) Inventor: Yoshiaki TANAKA, Shizuoka-ken (JP)

(73) Assignees: Toshiba Tec Kabushiki Kaisha, Tokyo (JP); Kabushiki Kaisha Toshiba, Tokyo (JP)

(21) Appl. No.: 13/399,510

(22) Filed: Feb. 17, 2012

Related U.S. Application Data
(60) Provisional application No. 61/472,169, filed on Apr. 5, 2011.

(30) Foreign Application Priority Data
Jan. 25, 2012 (JP) 2012-12608

(51) Int. Cl. G03G 15/08

(52) U.S. Cl. 399/258; 399/262

(57) ABSTRACT

According to one embodiment, there is provided an image forming apparatus in which a toner cartridge and a developer cartridge are interchanged, the toner cartridge including a toner storing section that stores a toner and the developer cartridge including a developer storing section that stores a developer, the apparatus including: the developer cartridge including a carrying section configured to carry the developer stored in the developer storing section and a power transmitting section configured to transmit power to the carrying section and enable length adjustment; a driving section configured to drive the power transmitting section of the developer cartridge; a developing device configured to store the developer carried by the carrying section; and a control section configured to control driving of the driving section.

### CROSS-REFERENCE TO RELATED APPLICATIONS

This application is based upon and claims the benefit of priority from the prior U.S. Patent Application No. 61/472,169, filed on Apr. 5, 2011, the entire content all of which is incorporated herein by reference.

This application is also based upon and claims the benefit of priority from the prior Japanese Patent Applications No. 2012-12608, filed on Jan. 25, 2012, the entire contents all of which are incorporated herein by reference.

### FIELD

Embodiments described herein relate generally to an image forming apparatus, a developer cartridge, and a method of adjusting the length of the developer cartridge.

### BACKGROUND

An image forming apparatus is known in which a serviceperson fills a two-component developer including a toner and a carrier in a developing device from a developer cartridge during shipment, during initial setting (installation), and during maintenance. After filling the two-component developer in the developing device from the developer cartridge, the serviceperson replaces the developer cartridge with a toner cartridge and fills the toner in the developing device from the toner cartridge. The developer cartridge in the past is a container having the same shape as the toner cartridge. However, an amount of the two-component developer of the developer cartridge is small compared with an amount of the toner stored in the toner cartridge. When the container having the same shape is used as the developer cartridge, the container has size larger than size necessary for the developer cartridge.

### DESCRIPTION OF THE DRAWINGS

FIG. 1 is a configuration diagram of an image forming apparatus in a first embodiment;

FIG. 2 is a perspective view of a power transmitting section of a developer cartridge in the first embodiment;

FIG. 3 is a perspective view of a power transmitting section of a toner cartridge in the first embodiment;

FIG. 4 is a perspective view of the developer cartridge and the toner cartridge;

FIG. 5 is a diagram of the divided power transmitting section of the developer cartridge;

FIG. 6 is a diagram of a bendable power transmitting section of a developer cartridge in a second embodiment;

FIG. 7 is a diagram of the bent power transmitting section of the developer cartridge in the second embodiment;

FIG. 8 is a top view of a state in which a retractable power transmitting section of a developer cartridge is extended in a third embodiment; and

FIG. 9 is a top view of a state in which the retractable power transmitting section of the developer cartridge is retracted in the third embodiment.

### DETAILED DESCRIPTION

In general, according to one embodiment, there is provided an image forming apparatus in which a toner cartridge and a developer cartridge are interchanged, the toner cartridge including a toner storing section that stores a toner and the developer cartridge including a developer storing section that stores a developer, the apparatus including: the developer cartridge including a carrying section configured to carry the developer stored in the developer storing section and a power transmitting section configured to transmit power to the carrying section and enable length adjustment; a driving section configured to drive the power transmitting section of the developer cartridge; a developing device configured to store the developer carried by the carrying section; and a control section configured to control driving of the driving section.

Embodiments will now be described in more detail with reference to the accompanying drawings. However, the same numerals are applied to the similar elements in the drawings, and therefore, the detailed descriptions thereof are not repeated.

### First Embodiment

A developer cartridge in a first embodiment includes a dividable power transmitting section. Since the power transmitting section is dividable, the length of the developer cartridge can be adjusted.

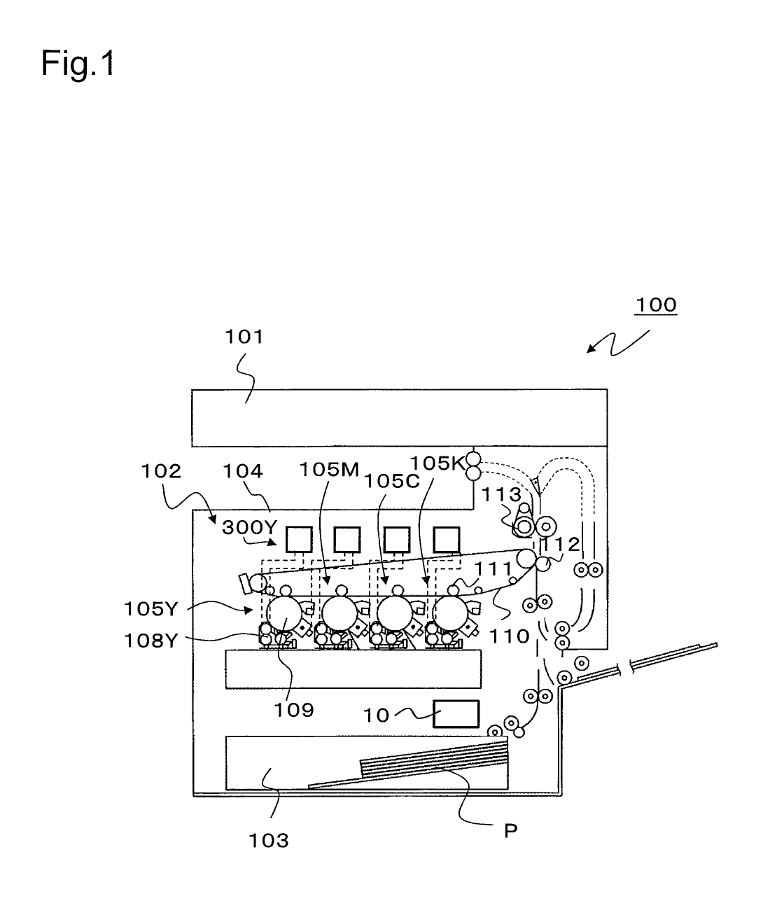

FIG. 1 is a configuration diagram of an image forming apparatus 100 according to the first embodiment. The image forming apparatus 100 includes a scanner section 101, an image forming section 102, a paper feeding cassette (a paper feeding section) 103, a paper discharge section 104, and a control section 10. The scanner section 101 optically scans the surface of an original document to thereby read an image on the original document as image data. The paper feeding cassette 103 stores printing media P. The paper discharge section 104 stores the printing media P subjected to image formation and discharged. The scanner section 101 is an example of an input section for an original document to be printed. Besides, for example, it is also possible to receive, with the input section, an original document created by a PC (Personal Computer), which is an external terminal, and print the original document as image data.

The image forming section 102 forms an image based on the image data on the printing media P. The image forming section 102 includes an image forming unit including four image forming stations 105Y, 105M, 105C, and 105K for yellow (Y), magenta (M), cyan (C), and black (K) arranged in parallel along the lower side of an intermediate transfer belt 110. The image forming apparatus 100 is explained as a color image forming apparatus. However, the image forming apparatus 100 may be a monochrome image forming apparatus.

The image forming stations 105Y, 105M, 105C, and 105K have the same configuration. Therefore, the configuration and the operation of the image forming station 105Y for yellow are explained. Components of the other image forming stations are denoted by reference numerals and signs corresponding to components of the image forming station 105Y.

The image forming station 105Y includes a developer cartridge 300Y, a developing device 108Y, and a photoconductive drum 109Y. The developer cartridge 300Y is a container that stores a two-component developer (hereinafter referred to as developer) including a toner of yellow (Y) and a carrier. The developer cartridge 300Y is detachably attachable. The developing device 108Y stores the two-component developer including the toner of yellow (Y) and the carrier. The developing device 108Y is detachably attachable. The developing device 108Y supplies the yellow toner to an electrostatic latent image on the photoconductive drum 109Y.

The intermediate transfer belt 110 is opposed to and in contact with the respective photoconductive drums 109. Primary transfer rollers 111 for primarily transferring toner images onto the intermediate transfer belt 110 are provided in positions of the intermediate transfer belt 110 opposed to the photoconductive drums 109. Toner images of the respective colors formed on the photoconductive drums 109 are sequentially transferred onto the intermediate transfer belt 110 by the primary transfer rollers 111 according to the movement of the intermediate transfer belt 110. A secondary transfer roller 112 is arranged in a secondary transfer section of the intermediate transfer belt 110.

The control section 10 controls the operation of the entire image forming apparatus 100. The control section 10 includes a CPU, a ROM (Read Only Memory), and a RAM (Random Access Memory), all of which are well known. The control section 10 controls the driving of a motor 205.

The control section 10 performs control to hold the printing medium P between the intermediate transfer belt 110 and the secondary transfer roller 112 and convey the printing medium P. When the printing medium P held by the intermediate transfer belt 110 and the secondary transfer roller 112 is conveyed, a transfer voltage is applied between the intermediate transfer belt 110 and the secondary transfer roller 112 to secondarily transfer a toner image on the intermediate transfer belt 110 onto the printing medium P. A fixing device 113 is located downstream of the secondary transfer roller 112 along a conveying direction of the printing medium P. The control section 10 performs control to convey the printing medium P, which is fed from the paper feeding cassette 103, to the fixing device 113 along the conveying path and through the secondary transfer roller 112. After the image is fixed by the fixing device 113, the control section 10 performs control to discharge the printing medium P having the image fixed thereon to the paper discharge section 104.

The image forming section 102 includes developer cartridges 300Y, 300M, 300C, and 300K (hereinafter, 300) and developing devices 108Y, 108M, 108C, and 108K (hereinafter, 108).

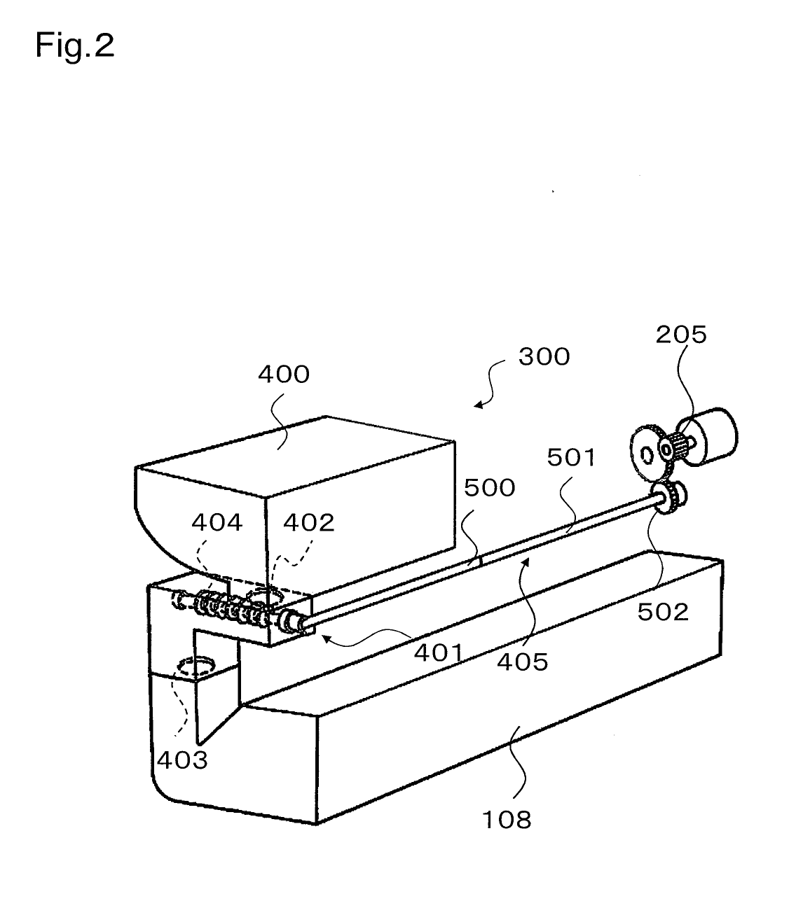

FIG. 2 is a perspective view of a power transmitting section 405 of the developer cartridge 300. In FIG. 2, for convenience of explanation, a cover is removed. In FIG. 2, the yellow toner is carried. The other magenta, cyan, and black toners are carried in the same manner as the yellow toner. The developer cartridge 300 includes a developer storing section 400, a developer carrying path 401, and the power transmitting section 405. The developer storing section 400 stores a developer. The developer carrying path 401 includes a first developer supply port 402, a second developer supply port 403, and an auger 404 (a carrying section).

The first developer supply port 402 is located in a lower part of the developer storing section 400 and above the developer carrying path 401. The first developer supply port 402 is a supply-side first supply port. A first developer supply port in an upper part of the developer carrying path 401 is a receiving-side first supply port. The supply-side first supply port and the receiving-side first supply port communicate with each other. A sponge is provided around the receiving-side first supply port. The sponge seals up a space between the supply-side first supply port of the developer storing section 400, which stores the developer, and the receiving-side first supply port of the developer carrying path 401 to prevent scattering of the developer. The supply-side first supply port and the receiving-side first supply port are collectively referred to as first developer supply port 402. The developer is supplied from the developer storing section 400 to the developer carrying path 401 through the communicating first developer supply port 402.

The second developer supply port 403 is located above the developing device 108 and in a lower part of the developer carrying path 401. The second developer supply port 403 in the lower part of the developer carrying path 401 is a supply-side second supply port. A second developer supply port in an upper part of the developing device 108 is a receiving-side second supply port. The supply-side second supply port and the receiving-side second supply port communicate with each other. A sponge is provided around the supply-side second supply port. The sponge seals up a space between the supply-side second supply port of the developer carrying path 401 and the receiving-side second supply port of the developing device 108 to prevent scattering of the developer. The supply-side second supply port and the receiving-side second supply port are collectively referred to as second developer supply port 403. The developer is supplied from the developer carrying path 401 to the developing device 108 through the communicating second developer supply port 403.

In the auger 404, a spiral carrying blade is integrally formed on the outer circumference of a rotating shaft. The auger 404 is rotatably disposed on the inside of the developer carrying path 401. The power transmitting section 405 is connected to one end of the auger 404. The auger 404 is rotated a predetermined amount by the motor 205, which is a driving section, via the power transmitting section 405. The motor 205 is fixed in a predetermined position of the image forming apparatus 100 and drives the auger 404.

The developer supplied from the developer storing section 400 to the developer carrying path 401 through the first developer supply port 402 moves ahead to the second developer supply port 403 according to the rotation of the auger 404. When the developer is carried to the second developer supply port 403 according to the rotation of the auger 404, the developer free-falls in a substantially vertical direction and is supplied to the developing device 108. The power transmitting section 405 is explained later.

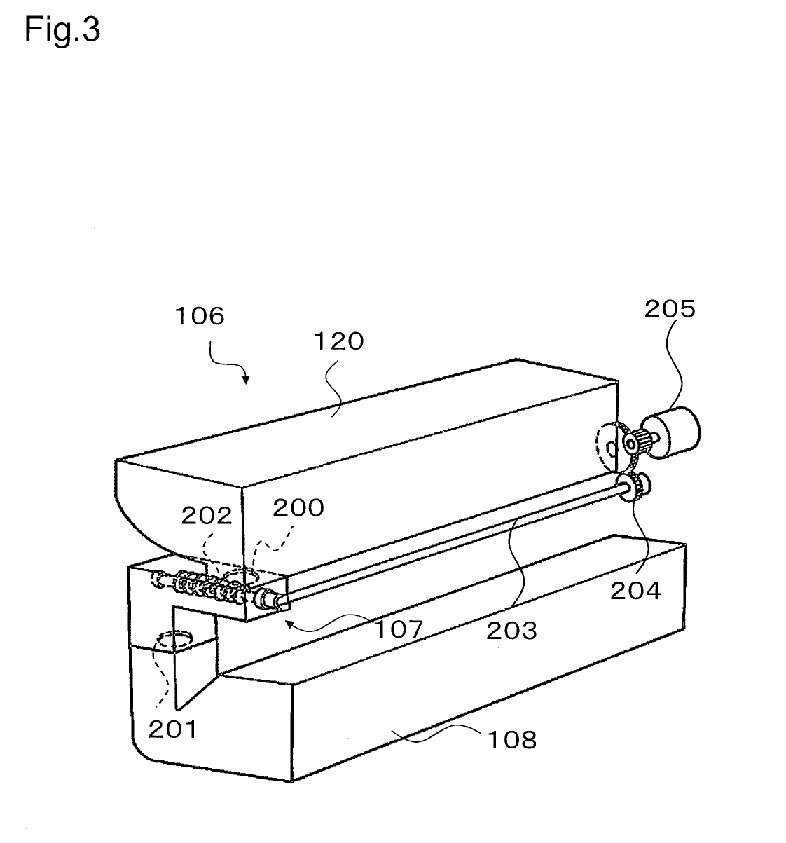

FIG. 3 is a perspective view of a power transmitting section 203 of a toner cartridge 106. In FIG. 3, for convenience of explanation, a cover is removed. A first toner supply port 200 is located in a lower part of a toner storing section 120 of the toner cartridge 106 and above a toner carrying path 107. A toner is supplied from the toner storing section 120 to the toner carrying path 107 through the first toner supply port 200.

A second toner supply port 201 is located above the developing device 108 and in a lower part of the toner carrying path 107. The toner is supplied from the toner carrying path 107 to the developing device 108 through the second toner supply port 201.

In an auger 202, a spiral carrying blade is integrally formed on the outer circumference of a rotating shaft. The auger 202 is rotatably disposed on the inside of the toner carrying path 107. The power transmitting section 203 is located at one end of the auger 202. A connecting section 204 connected to the motor 205, which is a power source, is located at one end of the power transmitting section 203. The connecting section 204 is, for example, a gear. The toner is supplied from the toner storing section 120 to the toner carrying path 107 through the first toner supply port 200 and carried to the second toner supply port 201 according to the rotation of the auger 202. When the toner is carried to the second toner supply port 201 according to the rotation of the auger 202, the toner free-falls in the substantially vertical direction and is supplied to the developing device 108. The control section 10 performs controls to supply the toner when an amount of the toner in the developing device 108 decreases to be equal to or smaller than a threshold according to image formation.

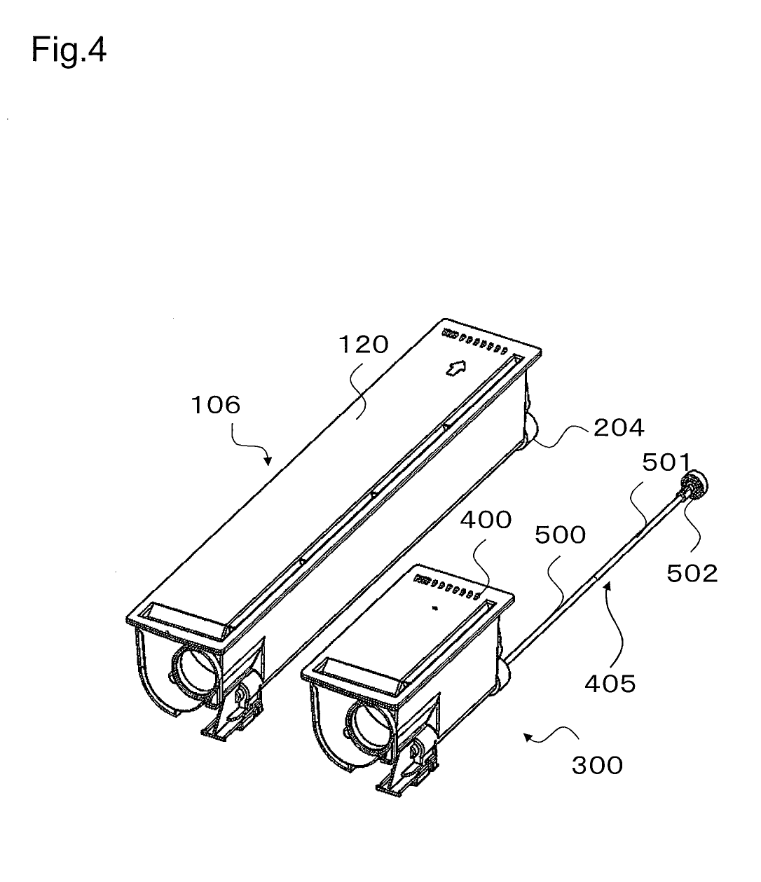

FIG. 4 is a perspective view of the developer cartridge 300 and the toner cartridge 106. The developer storing section 400 of the developer cartridge 300 has smaller length in a longitudinal direction compared with the toner storing section 120 of the toner cartridge 106. In FIG. 4, the length in the longitudinal direction of the toner storing section 120 is about twice as large as the length in the longitudinal direction of the developer storing section 400. Compared with the length in the longitudinal direction of the developer storing section 400, the length in the longitudinal direction of the toner storing section 120 is not limited to the double. The length in the longitudinal direction of the toner storing section 120 may be larger than the length in the longitudinal direction of the developer storing section 400 by other numbers. For example, the length in the longitudinal direction of the toner storing section 120 may be 1.5 times as large as the length in the longitudinal direction of the developer storing section 400. Compared with the volume of the toner storing section 120 of the toner cartridge 106 (a first volume), the volume of the developer storing section 400 of the developer cartridge 300 (a second volume) is small.

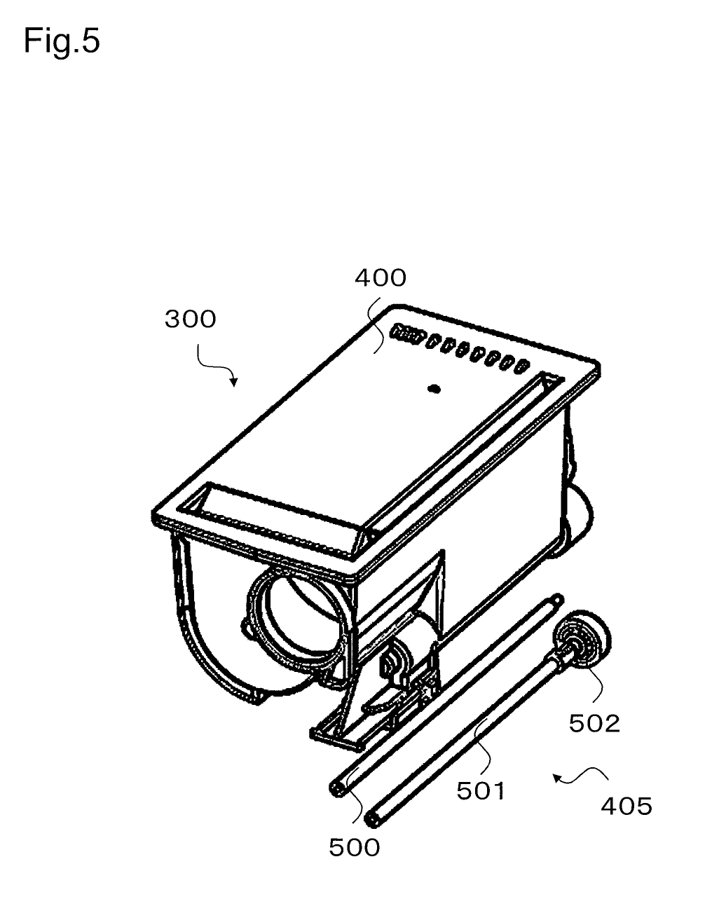

FIG. 5 is a diagram of the divided power transmitting section 405 of the developer cartridge 300. The power transmitting section 405 includes a first power transmitting section 500, a second power transmitting section 501, and a connecting section 502.

The first and second power transmitting sections 500 and 501 are, for example, shafts. The first and second power transmitting sections 500 and 501 are dividable. The first and second power transmitting sections 500 and 501 can be connected by, for example, a screw. The first and second power transmitting sections 500 and 501 are not always connected by the screw and may be connected by other methods.

When the developer is supplied to the developing device 108 by the developer cartridge 300, a user or a serviceperson connects the first and second power transmitting sections 500 and 501 and attaches the developer cartridge 300 to the image forming apparatus 100. When the toner cartridge 106 is already attached to the image forming apparatus 100, the user or the serviceperson detaches the toner cartridge 106 and then attaches the developer cartridge 300 to the image forming apparatus 100. The developer is supplied to the developing device 108, for example, during shipment, during initial setting, and during maintenance. During storage, during packaging, and the like, the developer cartridge 300 is stored in a state in which the power transmitting section 405 is divided.

The connecting section 502 may be the gear shown in FIG. 2 and may be a coupling shown in FIGS. 4 and 5. The connecting section 502 is connected to the motor 205 and rotated by the motor 205. In the above explanation, the power transmitting section 405 is divided into the two sections, i.e., the first power transmitting section 500 and the second power transmitting section 501. However, the power transmitting section 405 is not always divided into two. For example, the power transmitting section 405 may be divided into three or four.

When the developer is supplied to the developing device 108 by the developer cartridge 300 during the initial setting or during the maintenance, it is necessary to interchange the toner cartridge 106 and the developer cartridge 300. During the shipment, it is necessary to set the developer cartridge 300 in the image forming apparatus 100 and supply the developer to the developing device 108 and then replace the developer cartridge 300 with the toner cartridge 106.

The motor 205 is fixed in a predetermined position of the image forming apparatus 100. A position where the toner or the developer is supplied to the developing device 108 is also fixed. Therefore, the length in the longitudinal direction of the power transmitting section 405 of the developer storing section 400 smaller than the length in the longitudinal direction of the toner storing section 120 needs to be length for enabling connection of the connecting section 502 of the power transmitting section 405 to the motor 205. Therefore, the entire length in the longitudinal direction of the toner cartridge 106 and the entire length in the longitudinal direction of the developer cartridge 300 in connecting the first and second power transmitting sections 500 and 501 are substantially the same. The entire length in the longitudinal direction of the toner cartridge 106 is combined length of the toner storing section 120 and the connecting section 204, which is a power transmitting section. The entire length in the longitudinal direction of the developer cartridge 300 is combined length of the developer storing section 400 and the power transmitting section 405.

With the image forming apparatus 100 explained in the first embodiment, since the power transmitting section 405 can be divided, it is possible to reduce the developer cartridge 300 in size during storage, during packaging, and the like.

### Second Embodiment

A developer cartridge according to a second embodiment includes a bendable power transmitting section. Since the power transmitting section is bendable, the length of the developer cartridge can be adjusted. Components same as the components in the first embodiment are denoted by the same reference numerals and signs.

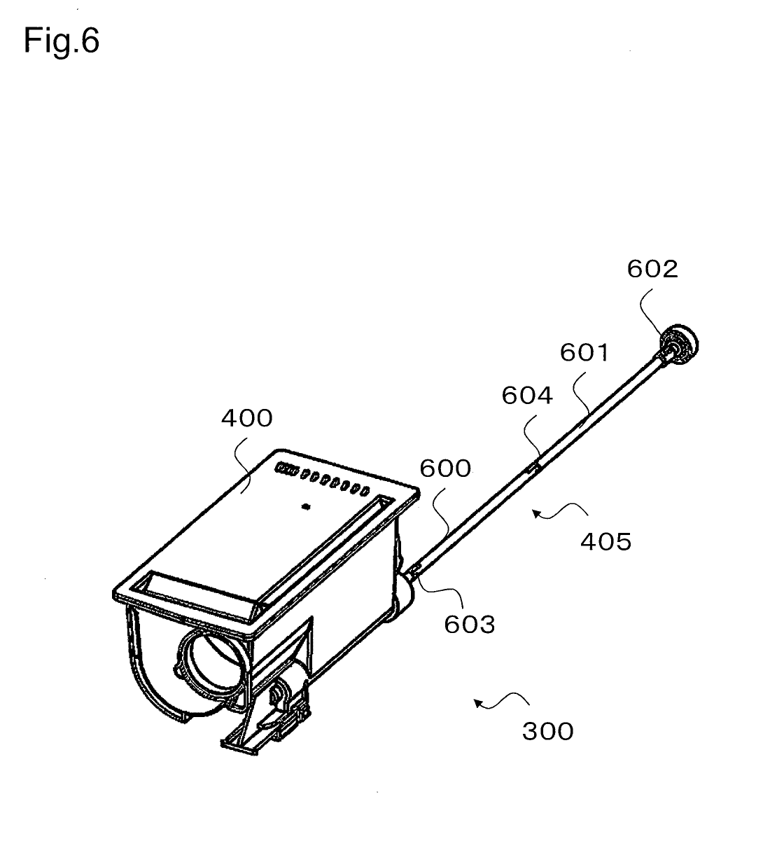

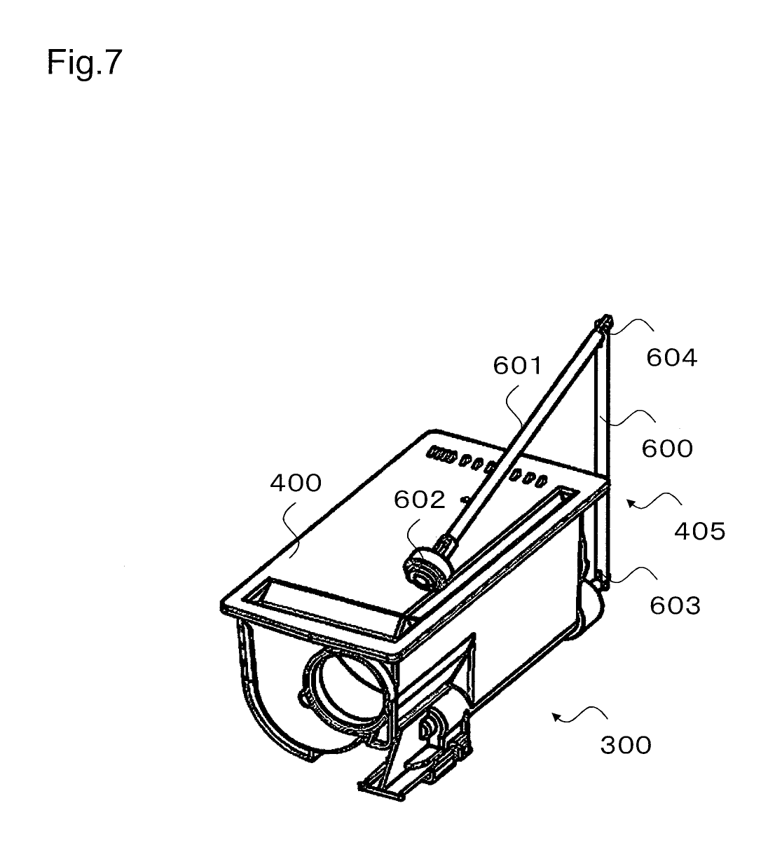

FIG. 6 is a diagram of the bendable power transmitting section 405 of the developer cartridge 300. FIG. 7 is a diagram of the bent power transmitting section 405.

The power transmitting section 405 includes a first power transmitting section 600, a second power transmitting section 601, a connecting section 602, and bending sections 603 and 604.

The first and second power transmitting sections 600 and 601 are, for example, shafts. The first and second power transmitting sections 600 and 601 are respectively connected in the bending sections 603 and 604 and are bendable. The bending sections 603 and 604 are, for example, hinges or pins. The first and second power transmitting sections 600 and 601 are not always connected by the hinges or the pins and may be bent by other methods.

When the developer is supplied to the developing device 108 by the developer cartridge 300, a user or a serviceperson attaches the developer cartridge 300 to the image forming apparatus 100 in a state in which the first and second power transmitting sections 600 and 601 are stretched, i.e., a state shown in FIG. 6. The developer is supplied to the developing device 108, for example, during shipment, during initial setting, and during maintenance. During storage, during packaging, and the like, the developer cartridge 300 is stored in a state in which the power transmitting section 405 is bent.

The connecting section 602 may be the gear shown in FIG. 2 or may be a coupling shown in FIGS. 6 and 7. The connecting section 602 is connected to the motor 205 and rotated by the motor 205. In the above explanation, the power transmitting section 405 is divided into the two sections, i.e., the first power transmitting section 600 and the second power transmitting section 601 and bent. However, the power transmitting section 405 is not always divided into two and bent. For example, the power transmitting section 405 may be divided into three and bent.

With the image forming apparatus 100 explained in the second embodiment, since the power transmitting section 405 can be bent, it is possible to reduce the developer cartridge 300 in size during storage, during packaging, and the like.

### Third Embodiment

A developer cartridge according to a third embodiment includes a retractable power transmitting section. Since the power transmitting section is retractable, the length of the developer cartridge can be adjusted. Components same as the components in the first embodiment are denoted by the same reference numerals and signs.

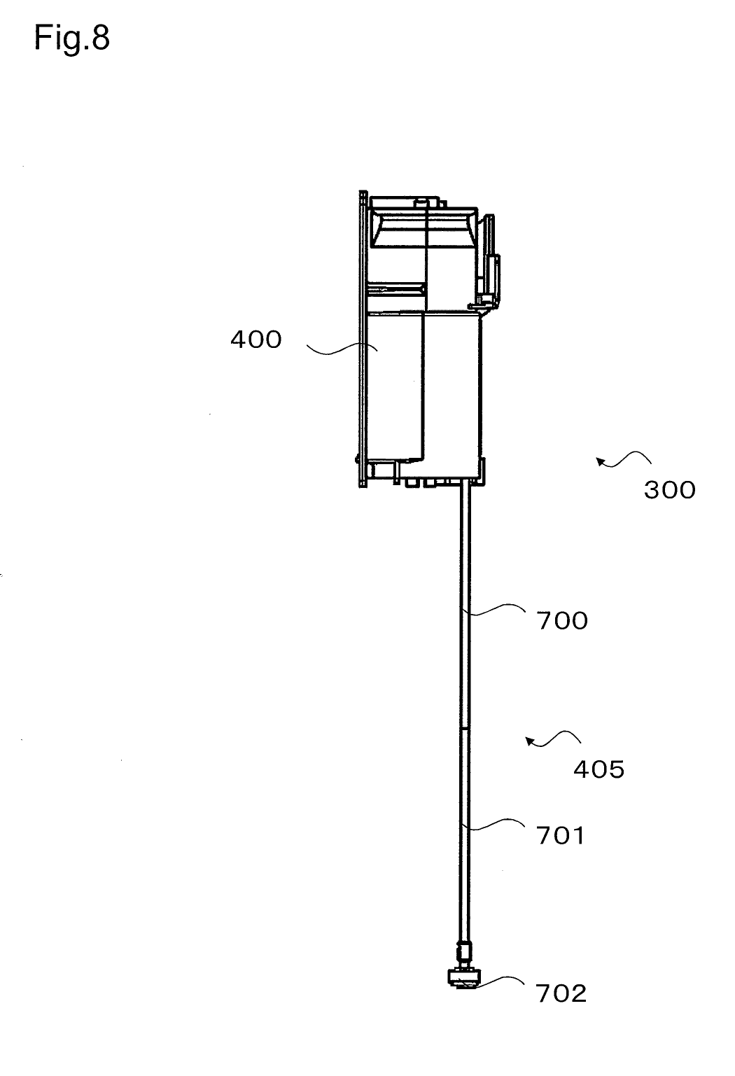

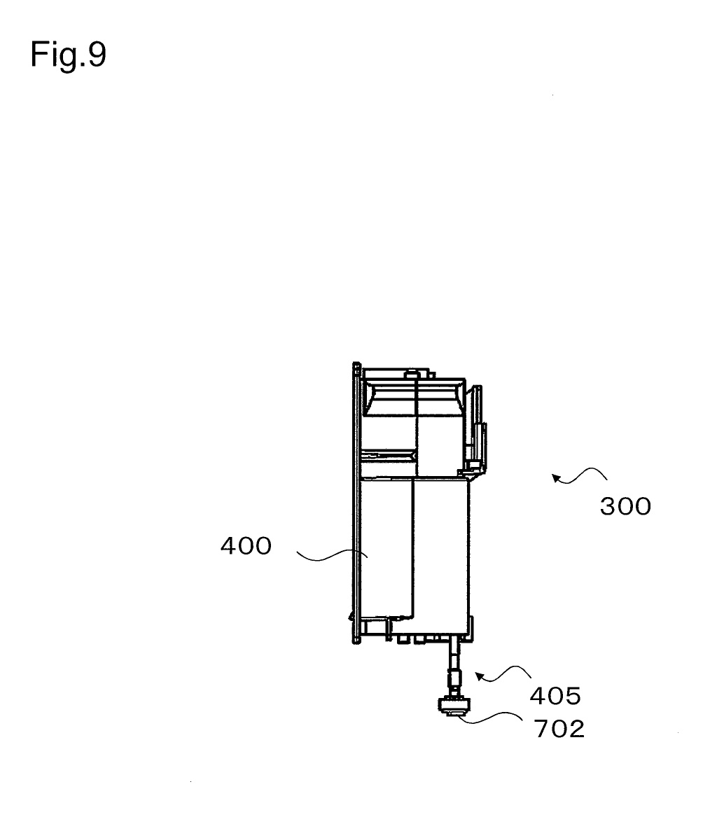

FIG. 8 is a top view of a state in which the retractable power transmitting section 405 of the developer cartridge 300 is extended. FIG. 9 is a top view of a state in which the power transmitting section 405 is retracted.

The power transmitting section 405 includes a first power transmitting section 700, a second power transmitting section 701, and a connecting section 702.

The first and second power transmitting sections 700 and 701 are, for example, shafts. The radiuses of the first and second power transmitting sections 700 and 701 are set different from each other. Therefore, one of the first and second power transmitting sections 700 and 701 can be stored in the other and the power transmitting section 405 is retractable like a rod antenna. When the developer is supplied to the developing device 108 by the developer cartridge 300, a user or a serviceperson attaches the developer cartridge 300 to the image forming apparatus 100 in a state in which the first and second power transmitting sections 700 and 701 are extended, i.e., a state shown in FIG. 8. The developer is supplied to the developing device 108, for example, during shipment, during initial setting, and during maintenance. During storage, during packaging, and the like, the developer cartridge 300 is stored in a state in which the power transmitting section 405 is retracted.

The connecting section 702 may be a gear shown in FIG. 2 or may be a coupling shown in FIGS. 8 and 9. The connecting section 702 is connected to the motor 205 and rotated by the motor 205. In the above explanation, the power transmitting section 405 is divided into the two sections, i.e., the first power transmitting section 700 and the second power transmitting section 701 and extended and retracted. However, the power transmitting section 405 is not always divided into two. For example, the power transmitting section 405 may be divided into three and extended and retracted.

With the image forming apparatus 100 explained in the third embodiment, since the power transmitting section 405 can be extended and retracted, it is possible to reduce the developer cartridge 300 in size during storage, during packaging, and the like.

The several embodiments are explained above. However, these embodiments are presented as exemplars and are not intended to limit the scope of the invention. These novel embodiments can be carried out in other various forms. Various omissions, substitutions, and changes of the embodiments are possible without departing from the spirit of the invention. These embodiments and modifications thereof are included in the scope and the gist of the invention and included in the scope of the inventions described in the claims and equivalents thereof.

What is claimed is:

1. An image forming apparatus in which a toner cartridge and a developer cartridge are interchanged, the toner cartridge including a toner storing section that stores a toner and the developer cartridge including a developer storing section that stores a developer, the apparatus comprising:
the developer cartridge including a carrying section configured to carry the developer stored in the developer storing section and a power transmitting section configured to transmit power to the carrying section and enable length adjustment;
a driving section configured to drive the power transmitting section of the developer cartridge;
a developing device configured to store the developer carried by the carrying section; and
a control section configured to control driving of the driving section.

2. The apparatus according to claim 1, wherein entire length in a longitudinal direction of the toner cartridge and entire length in the longitudinal direction of the developer cartridge during carrying of the developer are substantially same.

3. The apparatus according to claim 1, wherein length in a longitudinal direction of the developer storing section is small compared with length in the longitudinal direction of the toner storing section.

4. The apparatus according to claim 1, wherein
the toner storing section has a first volume, and
the developer storing section has a second volume smaller than the first volume.

5. The apparatus according to claim 1, wherein length of the power transmitting section is adjusted by division and connection.

6. The apparatus according to claim 1, wherein length of the power transmitting section is adjusted by bending and stretching.

7. The apparatus according to claim 1, wherein length of the power transmitting section is adjusted by retraction and extension.

8. A developer cartridge comprising:
a developer storing section configured to store a developer;
a carrying section configured to carry the developer stored in the developer storing section; and
a power transmitting section configured to transmit power to the carrying section, length of the power transmitting section being capable of being adjusted by division and connection, bending and stretching, and retraction and extension.

9. A method of adjusting length of a developer cartridge of an image forming apparatus in which a toner cartridge and a developer cartridge are interchanged, the toner cartridge including a toner storing section that stores a toner and has predetermined length in a longitudinal direction and the developer cartridge including a developer storing section that stores a developer and a power transmitting section that transmits a driving force, the method comprising:
using, as the power transmitting section of the developer cartridge, a power transmitting section, length of which is capable of being adjusted by division and connection, bending and stretching, or retraction and expansion; and
adjusting length in the longitudinal direction of the developer storing section of the developer cartridge on the basis of the power transmitting section, the length of which is adjusted.

10. The method according to claim 9, wherein entire length in the longitudinal direction of the toner cartridge and entire length in the longitudinal direction of the developer cartridge during carrying of the developer are substantially same.

11. The method according to claim 10, wherein the length in the longitudinal direction of the developer storing section is small compared with the length in the longitudinal direction of the toner storing section.

12. The method according to claim 9, wherein
the toner storing section has a first volume, and
the developer storing section has a second volume smaller than the first volume.
